(19) United States
(12) Patent Application Publication
(10) Pub. No.: US 2011/0016232 A1
(43) Pub. Date: Jan. 20, 2011

(54) TIME STAMPING APPARATUS AND METHOD FOR NETWORK TIMING SYNCHRONIZATION

(75) Inventors: Seung-Woo LEE, Daejeon-si (KR); Bhum-Cheol LEE, Daejeon-si (KR); Seung-Hwan KIM, Daejeon-si (KR); Woo-Young CHOI, Daejeon-si (KR); Tae-Whan YOO, Daejeon-si (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/828,622

(22) Filed: Jul. 1, 2010

(30) Foreign Application Priority Data
Jul. 15, 2009 (KR) 10-2009-0064565
Apr. 20, 2010 (KR) 10-2010-0036620

(51) Int. Cl. G06F 15/16

(52) U.S. Cl. 709/248

(57) ABSTRACT

A time stamping apparatus and method for network timing synchronization are provided. A receiving apparatus receives data from a transmitting apparatus, generates a synchronization pulse signal synchronized with a local clock of the transmitting apparatus based on the received data, wherein the received data include information regarding the transmission time of the data, measured using the local clock of the transmitting apparatus, and the receiving apparatus measures the reception time of the data using the synchronization pulse signal. Therefore, accurate network timing synchronization may be achieved.

### CROSS-REFERENCE TO RELATED APPLICATION

This application claims the benefit under 35 U.S.C. § 119(a) of Korean Patent Applications Nos. 10-2009-0064565, filed on Jul. 15, 2009 and 10-2010-0036620, filed on Apr. 20, 2010, the entire disclosures of which are incorporated herein by reference for all purposes.

### BACKGROUND

1. Field

The following description relates to network timing synchronization, and more particularly, to a time stamping technique for network timing synchronization.

2. Description of the Related Art

In general, network timing synchronization is performed in such a manner that a transmitter which transmits data measures a transmission time of the data using its local clock and a receiver which receives the data measures a reception time of the data using its local clock. However, due to potential differences between the transmitter's local clock signal and the receiver's local clock signal, a difference between the actual and measured reception times of the data can be generated.

Measurement errors with respect to data transmission and reception times cause errors in time offset and propagation delay time, which makes accurate network timing synchronization difficult. For this reason, the present inventor has studied a technique capable of achieving accurate network timing synchronization by accurately measuring data transmission and reception times.

### SUMMARY

The following description relates to a technique for achieving accurate network timing synchronization by accurately measuring data transmission and reception times.

According to one general aspect, a transmitting apparatus writes a transmission time of data in the data using its local clock, and a receiving apparatus, which receives the data from the transmitting apparatus, generates a synchronization pulse signal synchronized with the local clock of the transmitting apparatus based on the received data and then measures and writes a reception time of the received data using the synchronization pulse signal.

Accordingly, data transmission and reception times can be accurately measured using local clocks of a data transmission apparatus and a data reception apparatus, thereby achieving accurate network timing synchronization.

Other features and aspects will be apparent from the following detailed description, the drawings, and the claims.

### BRIEF DESCRIPTION OF THE DRAWINGS

FIG. 1 is a diagram illustrating an example of a time stamping apparatus for network timing synchronization.

FIG. 2 is a view for explaining an example of a process for network timing synchronization.

FIG. 3 is a diagram illustrating an example of a time stamping apparatus for network timing synchronization.

FIG. 4 is a flowchart illustrating an example of a time stamping method for network timing synchronization.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

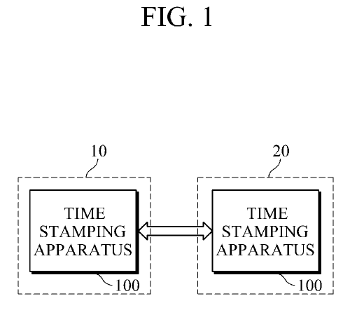

FIG. 1 is a diagram illustrating an example of a time stamping apparatus 100 for network timing synchronization. As shown in FIG. 1, the time stamping apparatus 100 achieves accurate network timing synchronization between a transmitting apparatus 10 and a receiving apparatus 20 by accurately measuring a data transmission time and a data reception time using a transmitter local clock and a receiver local clock respectively installed in the transmitting apparatus 10 and the receiving apparatus 20.

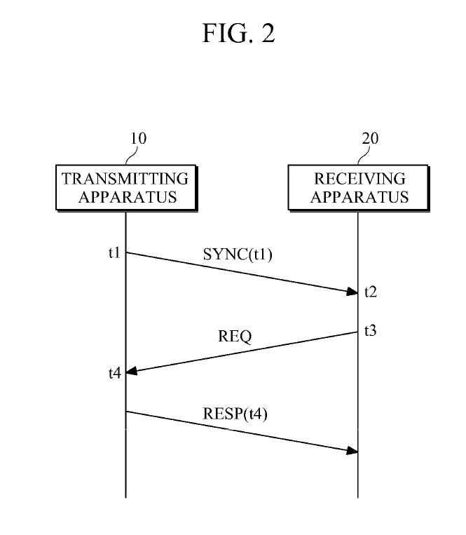

FIG. 2 is a view for explaining an example of a process for network timing synchronization. Hereinafter, the process for network timing synchronization between a transmitting apparatus 10 and a receiving apparatus 20 will be described with reference to FIG. 2. The transmitting apparatus 10 accurately measures a time stamp value t1 regarding a transmission time of a synchronization message SYNC using its local clock at regular intervals, includes the time stamp value t1 in the synchronization message SYNC and then transmits the synchronization message SYNC at regular intervals.

The receiving apparatus 20, which needs network timing synchronization, receives the synchronization message SYNC including the time stamp value t1 regarding the transmission time of the synchronization message SYNC from the transmitting apparatus 10, accurately measures a time stamp value t2 regarding a reception time of the synchronization message SYNC using a clock multiplied from a local clock of the transmitting apparatus 10 and then stores the time stamp values t1 and t2.

Also, the receiving apparatus 20 transmits a time information request message REQ to the transmitting apparatus 10, and accurately measures and stores a time stamp value t3 regarding the transmission time of the time information request message REQ using the local clock.

The transmitting apparatus 10 receives the time information request message REQ from the receiving apparatus 20, accurately measures a time stamp value t4 regarding the reception time of the time information request message REQ using a clock multiplied from the local clock from the receiving apparatus 20 and then transmits a time information response message RESP including the time stamp value t4 to the receiving apparatus 20.

Then, the receiving apparatus 20 receives the time information response message RESP including the time stamp value t4 from the transmitting apparatus 10 and stores the time stamp value t4.

As a result, the receiving apparatus 20 can accurately identify the time stamp value t1 regarding the transmission time of the synchronization message SYNC, the time stamp value t2 regarding the reception time of the synchronization message SYNC, the time stamp value t3 regarding the transmission time of the time information request message REQ and the time stamp value t4 regarding the reception time of the time information request message REQ, and calculate a time offset and a propagation delay time using the time stamp values t1 through t4, thereby achieving accurate network time synchronization.

The propagation delay time is an index indicating a degree of propagation delay on a network and is calculated as D=((t2−t1)+(t4−t3))/2, and the time offset is a value for correcting a time deviation and is calculated as O=((t2−t1)−(t4−t3))/2. The time offset is reflected to a time measured by the receiving apparatus 20 so as to synchronize the time measured by the receiving apparatus 20 with a time measured by the transmitting apparatus 10, thereby achieving network timing synchronization.

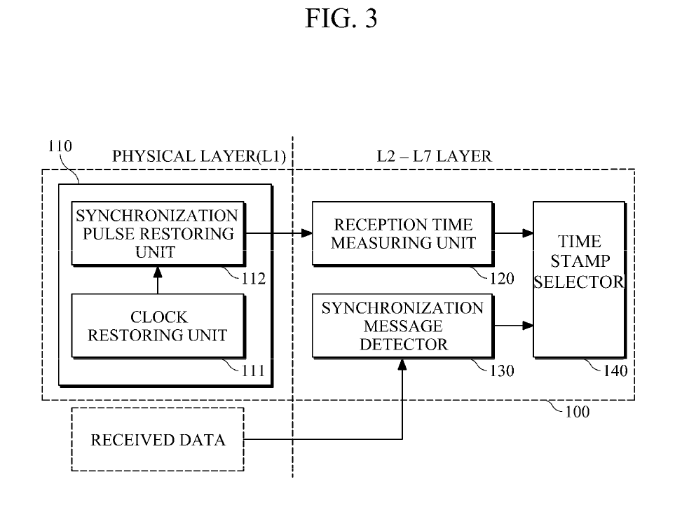

FIG. 3 is a diagram illustrating an example of a time stamping apparatus 100 for network timing synchronization. The time stamping apparatus 100 includes a synchronization pulse signal generator 110 and a reception time measuring unit 120.

The synchronization pulse signal generator 110 generates, when receiving data from a transmitting apparatus, a synchronization pulse signal synchronized with a local clock of the transmitting apparatus that has transmitted the data. The received data includes a time stamp value regarding the transmission time of the data, measured using the local clock of the transmitting apparatus.

At this time, the synchronization pulse signal generator 110 may identify a predetermined pattern of the received data to generate a synchronization pulse signal synchronized with the local clock of the transmitting apparatus. For example, the synchronization signal generator 110 may include a clock restoring unit 111 and a synchronization pulse restoring unit 112.

The clock restoring unit 111 restores a clock having the same clock frequency as the local clock of the transmitting apparatus from the received data. The synchronization pulse restoring unit 112 identifies a predetermined pattern of the received data and generates a synchronization pulse signal synchronized with the clock restored by the clock restoring unit 111.

The reception time measuring unit 120 measures a time stamp value regarding the reception time of the data using the synchronization pulse signal generated by the synchronization pulse signal generator 110. The synchronization pulse signal generated by the synchronization pulse signal generator 110 is a signal synchronized with the restored local clock of the transmitting apparatus and has the same clock frequency as the local clock of the transmitting apparatus.

That is, since a receiving apparatus can obtain a time stamp value regarding a transmission time of received data, the time stamp value measured using a local clock of a transmitting apparatus that has transmitted the data and included in the received data, and a time stamp value regarding a reception time of the data, the time stamp value measured using a clock multiplied from a restored local clock of the transmitting apparatus, measurement errors can be reduced compared to the case of measuring a time stamp value regarding a data transmission time and a time stamp value regarding a data reception time individually using local clocks of a transmitting apparatus and a receiving apparatus.

In other words, since a time stamp value regarding a data transmission time and a time stamp value regarding a data reception time can be measured using a local clock of a transmitting apparatus, accurate network timing synchronization can be performed through the process illustrated in FIG. 2.

Meanwhile, according to another example, the synchronization pulse signal generator 110 may be implemented on a physical layer of a receiving apparatus, and the reception time measuring unit 120 may be implemented on the upper layer of the physical layer of the receiving apparatus.

For example, a physical layer of the Ethernet is composed of a PCS block, a PMA block and a PMD block, and in the case of the 10G Ethernet, the PCS block includes a 64 bit/66 bit or 8 bit/10 bit encoder and decoder. The PCS block operates in the range of a restored local clock of a transmitting apparatus and the 64 bit/66 bit encoder codes 64 bits of block data into a 66-bit block.

The first two bits of the 66 bits are used to indicate whether the corresponding block is a data block or a control block and the remaining 64 bits (or 8 bytes) are a payload. A start character transmitted through an interface specification XGMII of the physical layer and MAC layer (L2 layer) of the 10G Ethernet is included in a control block and transmitted, and then placed in the first or fifth byte of the transmitted 8 bytes. The synchronization pulse signal generator 110 may recognize the start character to generate a synchronization pulse signal informing a start time of a frame in the PCS block.

That is, the current example is to perform accurate network timing synchronization by implementing the synchronization pulse signal generator 110 of using received data to generate a synchronization pulse signal synchronized with a local clock of a transmitting apparatus that has transmitting the data, on a physical layer of a receiving apparatus, and the reception time measurement unit 120 of measuring a time stamp value regarding the data reception time using the synchronization pulse signal, on the upper layer of the physical layer.

Meanwhile, according to another example, the time stamping apparatus 100 for network timing synchronization may further include a synchronization message detector 130 and a time stamp selector 140.

The synchronization message detector 130 determines whether or not the received data is a synchronization message. At this time, the synchronization message detector 130 may analyze a header or a predetermined pattern of the received data to determine whether the received data is a synchronization message or general data.

For example, according to the IEEE 1588 standard, a UDP port number, such as 319 or 320, is written in a UDP header field to indicate whether the corresponding data is a synchronization message or general data, and the synchronization message detector 130 checks the UDP port number to determine whether the data is a synchronization message or general data.

That is, since the receiving apparatus receives general data as well as synchronization messages and only the synchronization message are used for network timing synchronization, the synchronization message detector 130 is used to detect a synchronization message.

The time stamp selector 140 selects a time stamp value corresponding to the synchronization message detected by the synchronization message detector 130 from among the time stamp values measured by the reception time measuring unit 120.

The receiving apparatus stores a time stamp value regarding a data reception time measured by the reception time measuring unit 120 whenever receiving a general data frame as well as a synchronization message.

Since only a time stamp value regarding the reception time of a synchronization message is needed for network timing synchronization, the time stamp selector 140 selects a time stamp value corresponding to the synchronization message detected by the synchronization message detector 130 from among time stamp values measured by the reception time measuring unit 120.

Also, the time stamp selector 140 transfers the time stamp value corresponding to the synchronization message to the upper layer so as for the upper layer to perform accurate network timing synchronization through the process illustrated in FIG. 2.

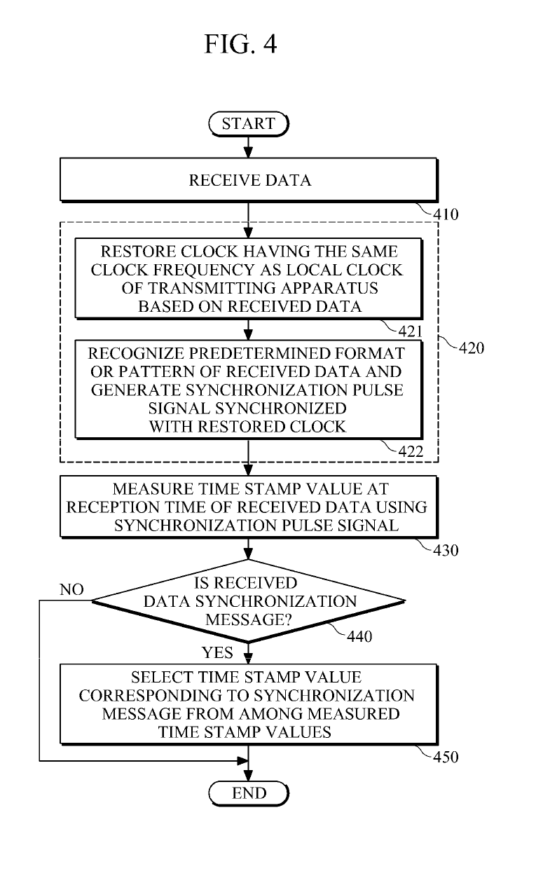

Hereinafter, a process of measuring a time stamp value regarding a data reception time for network timing synchronization in the time stamping apparatus for network timing synchronization will be described with reference to FIG. 4. FIG. 4 is a flowchart illustrating an example of a time stamping method for network timing synchronization.

In operation 410, if a transmitting apparatus measures a time stamp value regarding a data transmission time for network timing synchronization using its local clock, includes the time stamp value in data to be transmitted and then transmits the data including the time stamp value to a receiving apparatus, the receiving apparatus receives the data.

Then, in operation 420, the receiving apparatus generates a synchronization pulse signal synchronized with the local clock of the transmitting apparatus that has transmitted the data, based on the received data. At this time, the receiving apparatus may generate a synchronization pulse signal synchronized with the local clock of the transmitting apparatus by identifying a predetermined pattern of the received data.

For example, the operation 420 may include an operation 421 of restoring a clock and an operation 422 of restoring a synchronization pulse. The operation 421 of restoring the clock is to restore a clock having the same clock frequency as the local clock of the transmitting apparatus from the received data, and the operation 422 of restoring the synchronization pulse is to identify a predetermined pattern of received data and generate a synchronization pulse signal synchronized with the clock restored in operation 421.

Then, in operation 430, the receiving apparatus measures a time stamp value regarding the reception time of the data using the synchronization pulse signal generated in operation 420.

Accordingly, a time stamp value regarding the transmission time of data and a time stamp value regarding the reception time of the data can be measured using a local clock of a transmitting apparatus so that accurate network timing synchronization can be achieved.

Meanwhile, according to another example, the time stamping method for network timing synchronization may further include operation 440 of detecting a synchronization message and operation 450 of selecting a time stamp.

In operation 440, the receiving apparatus determines whether or not the received data, which is the time stamp value measured in operation 430, is a synchronization message. If it is determined in operation 440 that the received data is a synchronization message, in operation 450, the receiving apparatus selects a time stamp value corresponding to the synchronization message from among the time stamp values measured in operation 430.

In operation 440, the receiving apparatus may determine whether the corresponding received data is a synchronization message or general data by analyzing a header or a predetermined pattern of the received data.

That is, since the receiving apparatus receives general data as well as synchronization messages and only the synchronization message is used for network timing synchronization, in operation 440, a determination on whether received data is a synchronization message is done.

In operation 450 of selecting a time stamp, a time stamp value corresponding to the synchronization message detected in operation 440 is selected from among the time stamp values measured in operation 430.

The receiving apparatus stores, whenever receiving a general data frame as well as a synchronization message, a time stamp value regarding the data reception time in operation 430.

Since network timing synchronization requires only a time stamp value regarding the reception time of a synchronization message, in operation 450, a time stamp value corresponding to the synchronization message detected in operation 440 is selected from among the time stamp values measured in operation 430.

If a time stamp value corresponding to the synchronization message is selected in operation 450, the receiving apparatus performs accurate network timing synchronization, using the time stamp value regarding the reception time of the synchronization message, through the process described above in FIGS. 2 and 3.

Therefore, as described above, since a data transmission time and a data reception time can be accurately measured using the local clocks of a transmitting apparatus and a receiving apparatus, accurate network timing synchronization can be achieved.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A time stamping apparatus for network timing synchronization, comprising:
a synchronization pulse signal generator to receive data from a transmitting apparatus and generate a synchronization pulse signal synchronized with a local clock of the transmitting apparatus based on the received data; and
a reception time measuring unit to measure a time stamp value regarding the reception time of the data using the synchronization pulse signal.

2. The time stamping apparatus of claim 1, wherein the synchronization pulse signal generator is implemented on a physical layer of a receiving apparatus.

3. The time stamping apparatus of claim 1, wherein the reception time measuring unit is implemented on an upper layer of a physical layer of a receiving apparatus.

4. The time stamping apparatus of claim 1, wherein the synchronization pulse signal generator generates the synchronization pulse signal by identifying a predetermined pattern of the received data.

5. The time stamping apparatus of claim 4, wherein the synchronization pulse signal generator comprises:
a clock restoring unit to restore a clock having the same clock frequency as the local clock of the transmitting apparatus based on the received data; and
a synchronization pulse restoring unit to identify the predetermined pattern of the received data and generate a synchronization pulse synchronized with the clock restored by the clock restoring unit.

6. The time stamping apparatus of claim 1, further comprising:
a synchronization message detector to determine whether or not the received data is a synchronization message; and
a time stamp selector to select a time stamp value corresponding to a synchronization message detected by the synchronization message detector from among time stamp values measured by the reception time measuring unit.

7. The time stamping apparatus of claim 6, wherein the synchronization message detector determines whether the received data is a synchronization message or general data by analyzing a header or the predetermined pattern of the received data.

8. The time stamping apparatus of claim 6, wherein the time stamp selector transfers a time stamp value corresponding to the synchronization message to an upper layer.

9. A time stamping method for network timing synchronization comprising:
at a receiving apparatus, receiving data;
at the receiving apparatus, generating a synchronization pulse signal synchronized with a local clock of a transmitting apparatus that has transmitted the data, based on the data; and
at the receiving apparatus, measuring a time stamp value regarding the reception time of the data using the synchronization pulse signal.

10. The time stamping method of claim 9, wherein the generating of the synchronization pulse signal comprises at the receiving apparatus, generating the synchronization pulse signal synchronized with the local clock of the transmitting apparatus by identifying a predetermined pattern of the data.

11. The time stamping method of claim 9, wherein the generating of the synchronization pulse signal comprises:
restoring a clock having the same clock frequency as the local clock of the transmitting apparatus from the data; and
recognizing a predetermined pattern of the data and generating a synchronization pulse signal synchronized with the restored clock.

12. The time stamping method of claim 9, further comprising:
at the receiving apparatus, determining whether or not the data, which is the measured time stamp value, is a synchronization message; and
at the receiving apparatus, selecting, if it is determined that the data is a synchronization message, a time stamp value corresponding to the synchronization message from among time stamp values obtained by measuring reception times of data.

13. The time stamping method of claim 12, wherein the determining of whether the data is the synchronization message comprises determining whether the data is the synchronization message or general data by analyzing a header or a predetermined pattern of the data.
